(19) United States
(12) Patent Application Publication
(10) Pub. No.: US 2005/0006111 A1
(43) Pub. Date: Jan. 13, 2005

(54) Wedge shaped planting tool and method for using same

(75) Inventor: Helen R. Wherry, Chicago, IL (US)

Correspondence Address: JoAnne M. Dension;DENISON & ASSOCS., PC, #1608, 212 W. Washington St., Chicago, IL, 60606-3487, US

(73) Assignee: Wherry Enterprise of Illinois, Inc.

(21) Appl. No.: 10/911,960

(22) Filed: Aug. 5, 2004

Related U.S. Application Data
(63) Continuation-in-part of application No. 10/338,406, filed on Jan. 8, 2003.
(60) Provisional application No. 60/349,821, filed on Jan. 22, 2002.

(51) Int. Cl. A01B 1/00

(52) U.S. Cl. 172/371

(57) ABSTRACT

A method and device for planting that includes inserting a hand held gardening tool, having a wedge portion and a handle portion, into soil to loosen and displace soil by manipulating the tool side to side and back and forth, while at the same time, depositing the displaced soil to adjacent areas with minimal disturbance to surrounding plants; removing the tool from the newly created aperture; and inserting at least one plant into the aperture. The handle of the tool is easy to grip and manipulate, and can be spherical or angular in shape. The tool itself can be made hollow or solid. The handle and wedge portions can be made to be one fluid connected unit, or distinct connected units, according to aesthetic and durability values.

### FIELD OF THE INVENTION

The present invention relates to the field of planting tools. More specifically, it relates to a hand held gardening tool including a wedge shaped portion attached to a handle portion and an improved method for using such a tool.

### BACKGROUND OF THE INVENTION

Currently, in the marketplace, there are available a wide variety of tools which are, for the most part geared towards splitting wood with a head portion and a splitting portion which allows the user to hammer the head portion while the splitting portion is wedged into the wood, and thus, splits it. Other gardening tools are also available that have a handle portion and a digging portion that can cut into, and then scoop out, the target soil thereby removing it and other items located therein. There are none, however, that can be easily, quickly, and conveniently maneuvered back and forth, and from side to side with minimal wrist strain, to create a hole in the soil, while at the same time, depositing the displaced soil in adjacent areas without disturbing the surrounding vegetation. Although there are several related patents, they generally disclose cumbersome tools that can scoop soil but have to remove the displaced soil by performing additional and separate acts rather than the one fluid step suggested by the planting tool. Notably, most of the related patents involve devices directed to splitting timber. None of these devices, however, is directed to gardening, and more specifically, creating holes in which to house plants with such swift and fluid ease of movement.

For example, one such patent disclosed in the prior art is U.S. Pat. No. 542,559, issued to W. Harmon, discloses a wedge directed to splitting wood that has an iron casing for the wooden wedge portion, a head portion that has an iron band around it, and straps that traverse the sides of the wedge. The iron band around the head is necessary to the device so that the wooden wedge will not split on impact. The metal casing that houses the wooden wedge is open at the sides so that the wood can expand on impact. Yet an additional related disclosure is found in U.S. Pat. No. 759,868, issued to A. Eich, which is also directed to splitting timberwood. Rather than smooth substantially planar sides, the side faces of the wedged portion are grooved the entire length of the wedge to prevent displacement of the device on impact. An additional feature is a flat head portion with rounded sides necessary to improve the splitting quality.

Yet another patent, U.S. Pat. No. 841,517, issued to G. Harris, discloses a device that is meant to receive blows from a hammer. Additionally, the sophisticated device is comprised of multiple parts for a chisel including, for example, a socket to receive the head and a shoulder at the base of the head. The head itself has grooves, flanges, and a ferrule.

Yet anther interesting disclosure was U.S. Pat. No. 1,032,316, issued to W. Walters. The Walters device is directed at splitting timber and comprises three parts; a cap ring, a steel point, and a wooden core. The steel point is flared at the end, and the sides, as with the Eich device, U.S. Pat. No. 759,868, of the device have grooves for traction and to prevent displacement of the device on impact. Still another patent, U.S. Pat. No. 1,195,423, issued to A. Waters, discloses a device for splitting wood. The device comprises a wedge that has a body that can be elongated, a long head portion, and shoulders that define the maximum width of the device. The device then tapers to a head that is substantially shorter in width than the shoulders.

A more recent European published Patent Application, application no. 81200178.2, publication no. 0047537A1, discloses a cone shaped device used for cleaving pieces of wood. The conical wedge has a circular or oval cross-section and exerts an automatic splitting effect in wood that is substantially perpendicular to the naturally occurring weak zones in the wood. The conical shape gives the device a claimed advantage over the known flat wedges. Notably, a design patent, Des. 283,483, issued to G. Hillinger, discloses a shaped wedge design with a front and back face. The Hillinger design can be distinguished from the present invention because the Hillinger design is equipped with rollers imbedded into the front and rear faces of the wedge portion. Roller elements could easily clog in soil, and so the design of this device would not be particularly useful as a gardening or planting tool.

One somewhat related patent found in the prior art was U.S. Pat. No. 1,531,100, issued to J. Howard, which discloses the use of a triangular spade shaped planting tool with an elongated handle which is intended for use in the standing position. However, with the Howard device, strain on the wrist, hand, arms and shoulder is increased during the hole forming procedure. The Howard device notes that it is for furrowing or molding the soil and it does not disclose a procedure or method for simply making holes for planting soil plugs.

Thus, nowhere in the prior art is seen a gardening tool that can easily, quickly, and conveniently make a hole in soil with minimal wrist strain, while at the same time, fill in adjacent holes with the displaced soil.

### SUMMARY OF THE INVENTION

The present invention comprises a method for inserting a hand held gardening tool, that has a handle portion attached to a wedge portion, into soil; manipulating the gardening tool forward and backwards, and side to side, thereby displacing soil to adjacent areas, while at the same time, creating an aperture; removing the gardening tool from the soil; and inserting at least one plant. The handle portion of the gardening tool can be spherical in configuration, as depicted in the preferred embodiments, and alternatively can be angular. The handle portion is comfortable to grip for any shape and size hand and for easy manipulation of the gardening tool. The wedge portion of the gardening tool has a tapered end opposing the end attached to the wedge portion. The tapered end of the wedge portion has a dual purpose: first, it can be easily slid into soil and by moving it back and forth, and from side to side, an aperture is created, while at the same time, the soil displaced from the aperture is deposited on adjacent areas; and second, the tapered shape of the wedge portion can smoothly loosen and remove plants in containers without losing the configuration that the mold of the container has created for the packing soil and root system.

The handle and wedge portions can be made as a fluid connected unit, or as discrete units. The handle and wedge portions can be composed of a composite material selected from, but not limited to, one or more groups of materials; wood, metal, metal composites, anodized metals, aluminum, fiberglass, and plastic. By selecting from any of the aforementioned materials, in addition to other materials, the gardening tool used in the method for planting will be durable, weather resistant, aesthetically pleasing, and lightweight such that it may greatly decrease wrist strain during the hole formation process. In the case of a heavy metal, it is anticipated, that where desired, the tool can be made with a hollow interior.

The foregoing disclosure taken together with other features and advantages of the present invention can be readily derived from the following detailed description of the drawings taken in conjunction with the accompanying drawings present herein, and should be considered as within the overall scope of the invention.

### OBJECTS OF THE INVENTION

A primary object of the present invention is to provide a method for planting that is convenient and quick.

It is a primary object of the present invention to provide a hand held gardening tool having a handle and a wedge shaped soil loosening portion for the method of planting that has a wedge shaped portion with a tapered end so that the wedge can easily be inserted into soil.

It is yet another primary object of the present invention to provide a gardening tool that has a wedge shaped portion with a tapered end that can easily displace soil thereby creating a planting aperture.

Still another primary object of the present invention to provide a hand held gardening tool that has a wedge shaped portion with a tapered end so that by displacing soil, an aperture is thereby created which is adopted to fit a standard sized plant plug.

It is another primary object of the present invention is to provide a gardening tool that has a wedged shaped portion that can be used to displace soil, while at the same time, fill in adjacent holes with the displaced soil with minimal disturbance to surrounding plants.

Yet another primary object of the present invention is to provide a gardening tool that has a wedge shaped portion and a handled portion such that the handle portion is ergonomically shaped for easy manipulation of the tool.

Still another primary objective of the present invention is to provide a gardening tool that is durable, weather resistant, aesthetically pleasing, and lightweight.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

Exemplary embodiments of the present invention are described with reference to the following drawings, wherein:

FIG. 1 is a front and side perspective elevation of one preferred embodiment of the present invention;

FIG. 2 is a side elevation view of one preferred embodiment of the present invention;

FIG. 3 is a front elevation view of one preferred embodiment of the present invention;

FIG. 4 is a top elevation view of one preferred embodiment of the present invention;

FIG. 5 is a side elevation view of one preferred embodiment of the present invention as it is shown in use displacing the soil to create a planting aperture;

FIG. 6 is a side elevation view of one preferred embodiment of the present invention; and

FIG. 7 is a side elevation view of one preferred embodiment of the present invention.

### DETAILED DESCRIPTION

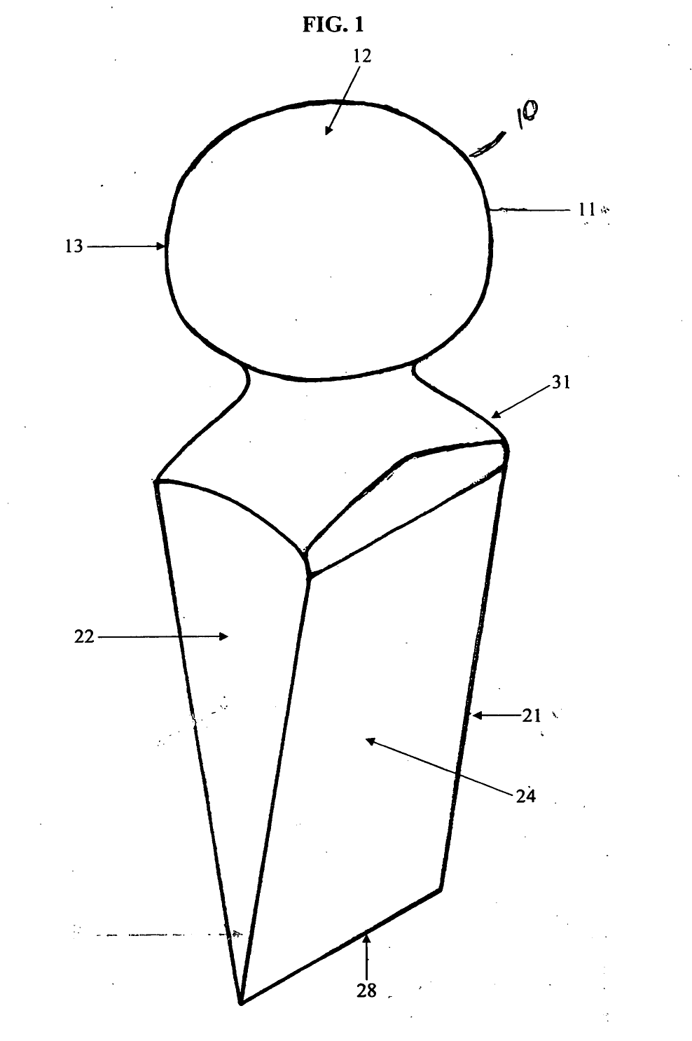

The present invention is directed to a gardening tool. FIG. 1 shows a front and side perspective view of the gardening tool 10. The tool has a handle portion 11 and a wedge portion 21. The handle portion 11 is substantially spherical in configuration to allow the user to grip the tool ergonomically in the palm of the hand with minimal strain on the wrist. The wedge portion 21 has two substantially planar sides 24 that terminate in an apex 28. In this preferred embodiment, the handle portion 11 and the wedge portion 21 are integral to each other. The gardening tool 10 can be made from, but is not limited to, the following materials including metal, metal composites, sintered metals, anodized metals, aluminum, wood, plastic, and fiberglass.

In one preferred embodiment, as depicted in FIG. 1, the gardening tool 10 is approximately 5 to 7 inches, but more preferably approximately 7 inches long from the top of the handle portion 11 to the apex 28 of the wedge portion 21, with the wedge portion 21 being approximately 3 to 6″, but more preferably 4.5 inches long, the two substantially planar surfaces 24 being approximately 1.5 to 2.5″, but more preferably 2 inches wide. This preferred embodiment depicted in FIG. 1 is of a size that allows a user to smoothly and easily plant individual plant plugs from similarly shaped 12-0-4 flower flats. The precise dimensions of the gardening tool 10 is unimportant and can be as large or small as needed to achieve the desired result of planting a particular sized plant plug.

FIG. 1 also shows one of two substantially planar side surfaces, side surface 22, which can be used to displace additional soil when gardening tool 10 is moved from side to side. In one preferred embodiment, handle portion 11 may have a side 13 which is slightly planar.

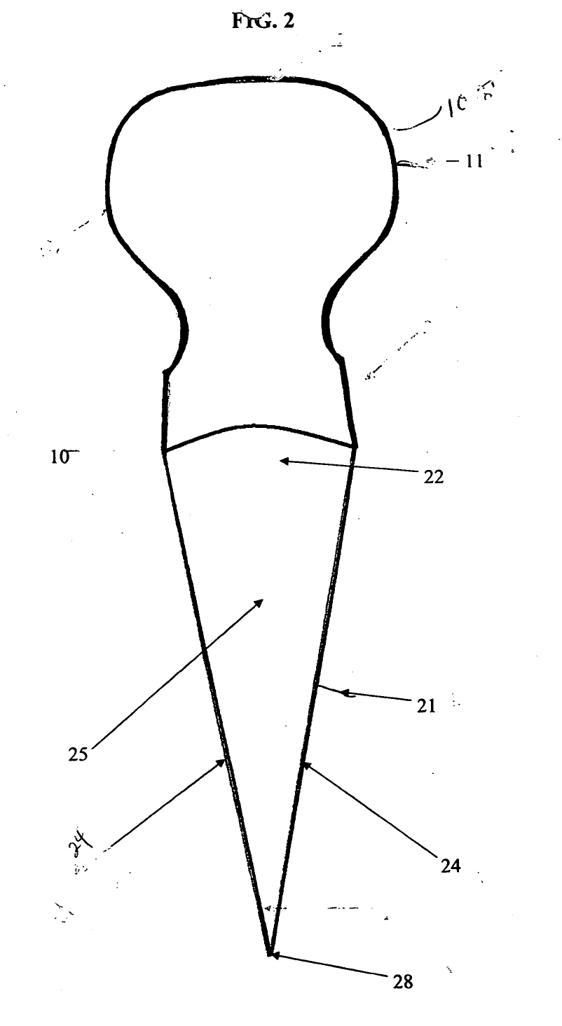

FIG. 2 shows the side elevation view of the gardening tool 10 with the handle portion 11 attached, and integral, to the wedge portion 21. The substantially planar surfaces 24 terminate in an apex 28. Substantially planar side surface 25 is also clearly shown.

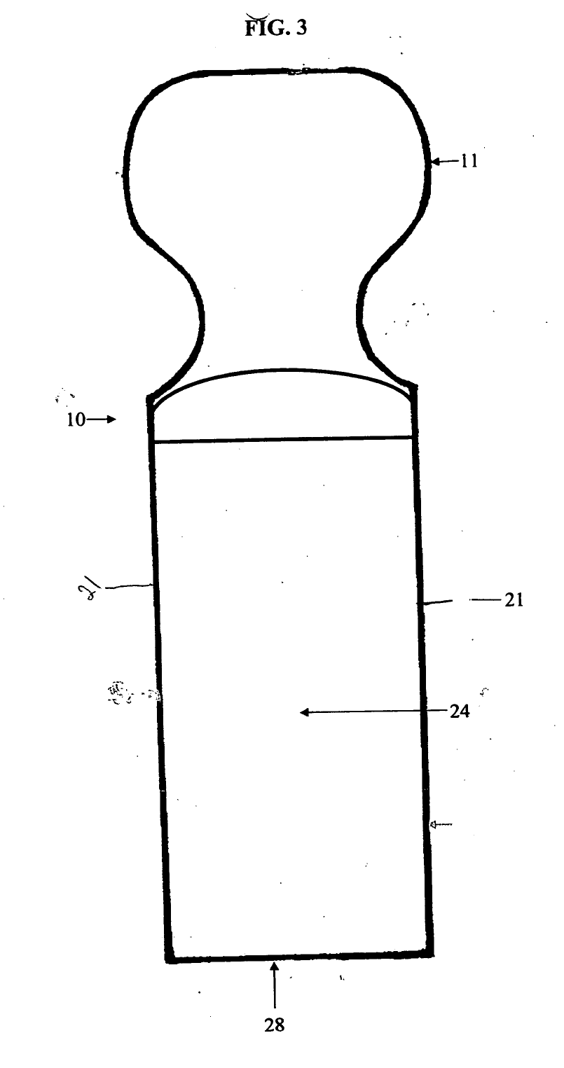

FIG. 3 shows another side elevation view of the gardening tool 10, the handle portion 11, and the wedge shaped portion 21. The substantially planar surface 24 terminates in an apex 28.

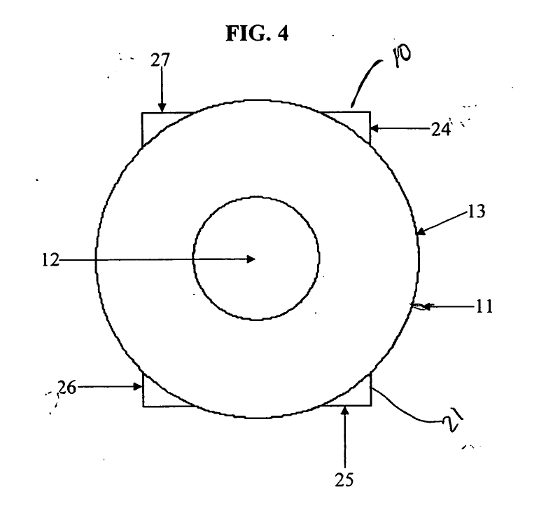

FIG. 4 shows a top elevation view of the gardening tool 10 from the top of the handle portion 11. The wedge portion 21 is directly beneath top shoulders 21, 24, 26 and 27. Top shoulders 21, 24, 26 and 27 are clearly visible from above. Wedge portion 25 is located directly beneath top shoulders 21, 24, 26 and 27. The top portion 12 of gardening tool 10 creates a bearing surface for the palm of the user's hand.

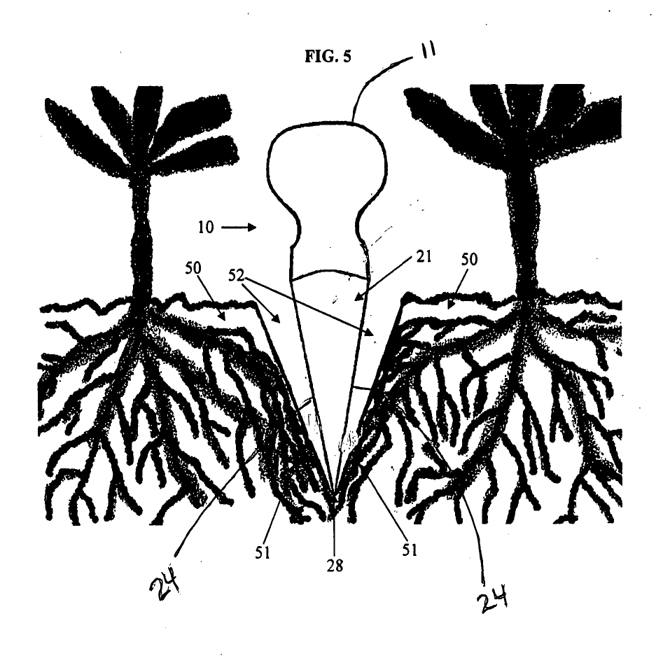

FIG. 5 shows the gardening tool 10 in use displacing soil 50 and nearby plant roots 51, by rocking the gardening tool 10 back and forth, and side to side, thus, creating an aperture 52. The substantially planar sides 24 of the wedge portion 21 terminate in an apex 28. The handle portion 11 in this preferred embodiment is not necessarily integral to the wedge portion 21 but in other preferred embodiments, it can be attached via a manner known to those in the art, such as by using screws, rivets, or other fastening devices, welding, or using an appropriate adhesive. The manipulation of the gardening tool 10 is easier and less fatiguing to the user's wrist than the extending and flexing digging motion required to remove soil with a trowel and other known gardening tools. By displacing rather than removing soil, planting with the gardening tool 10 can be accomplished more quickly because the soil does not need to be relocated all the while making a mess.

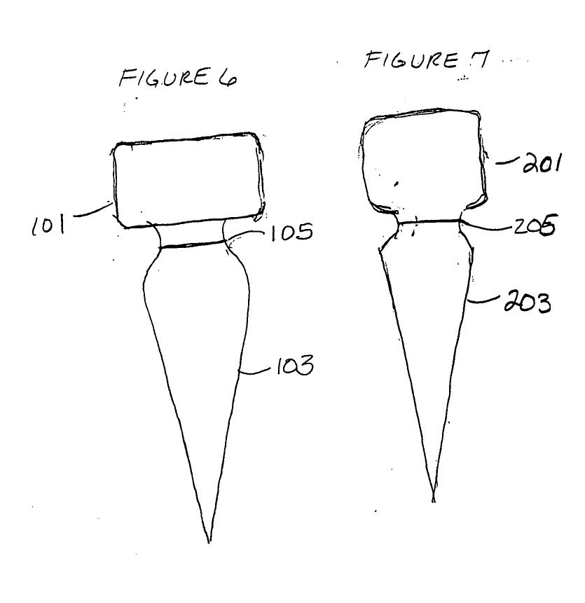

The gardening tool 10 is also contemplated to have a substantially angular handle portion 101, as depicted in FIG. 6, and a substantially cylindrical handle portion 201, as depicted in FIG. 7. In FIG. 6, the handle portion 101 is not integral to the wedge portion 103, but is configured in discrete elements with seam line 105 by means commonly known in the art, such as adhesives, fastening elements, heat staking and the like. In FIG. 7 similarly, the handle portion 201 is not integral to the wedge portion 203 but is configured in discrete elements with seam line 205. The gardening tool 10 can be made in different colors to be aesthetically pleasing and so that the tool can be easily located if placed on the ground or in a garden bed.

The features and advantages of the invention are apparent from the detailed specification and it is intended by the appended claims to cover all such features and advantages of the invention which fall within the scope of the invention. Since numerous modifications and variations will readily occur to those skilled in the art, it is not desired to limit the invention to the exact construction and operation illustrated and described, and therefore, all suitable modifications and equivalents fall within the scope of the invention.

1. A hand held gardening tool comprising: means for gripping the tool with the user's hand, a substantially wedge shaped portion adjacent the means for gripping the tool, with the wedge further having a substantially planar front face and a substantially planar rear face, with the overall length of the tool substantially 12″ or less.

2. The gardening tool of claim 1 wherein the means for gripping the tool comprises a substantially spherical handle portion.

3. The gardening tool of claim 1 wherein the means for gripping the tool comprises a substantially cylindrical handle portion.

4. The gardening tool of claim 1 wherein the means for gripping the tool comprises a substantially angular handle portion.

5. The gardening tool of claim 1 wherein the tool may be made from a material containing one or more of the following substances: corrosion resistant metal, a copolymer, an anodized metal or aluminum.

6. The gardening tool of claim 5 wherein the copolymer comprises a molded, high impact resistant resin.

7. A method for planting comprising the steps of:
a. providing a gardening tool with a handle portion and a wedge portion;
b. inserting the gardening tool into soil;
c. manipulating the gardening tool back and forth, and from side to side, thereby creating a wedge shaped aperture and displacing the soil from the aperture to adjacent areas of soil;
d. removing the gardening tool from the aperture; and
e. inserting at least one plant into the aperture.

8. A method as claimed in claim 6, wherein the wedge portion is composed of a composite material selected from one or more groups of materials; wood, metal, fiberglass, stainless steel, copper, aluminum, coated copper, and copolymers.

9. A method os claimed in claim 7, wherein the handle portion is composed of a composite material selected from one or more groups of material; wood, metal, fiberglass, stainless steel, copper, aluminum, coated copper, and copolymers.

10. A method as claimed in claim 7, wherein the gardening tool is solid.

11. A method as claimed in claim 7, wherein the handle portion is substantially spherical.

12. A method as claimed in claim 7, wherein the handle portion is substantially cylindrical.

13. A method as claimed in claim 7, wherein the handle and wedge portions are integral to each other.

14. A method as claimed in claim 7, where the handle and wedge portions are discrete units permanently secured to one another.

15. The method as claimed in claim 7 further comprising the step of:
creating at least one planting aperture with the gardening tool;
planting a garden plant into the aperture;
creating at least one subsequent planting aperture, whereby when soil is displaced during the creation of said aperture, at least a portion of adjacent soils fills in the area surrounding the previous planting.
